(19) United States
(12) Patent Application Publication
(10) Pub. No.: US 2017/0061686 A1
(43) Pub. Date: Mar. 2, 2017

(54) STAGE VIEW PRESENTATION METHOD AND SYSTEM

(71) Applicant: Hai Yu, Woodbury, MN (US)

(72) Inventor: Hai Yu, Woodbury, MN (US)

(21) Appl. No.: 14/838,701

(22) Filed: Aug. 28, 2015

(51) Int. Cl. G06T 19/00; G06T 7/00; G06T 3/00; H04N 5/232

(52) U.S. Cl. CPC G06T 19/003; H04N 5/23238; G06T 7/0081; G06T 3/0006; G06T 2207/10016; G06T 2207/20221; G06T 2207/30232

(57) ABSTRACT

Method and system providing service of focused view navigation inside a panorama view to crowd service users, where each service user has individually specified view region of interest. First, a high resolution panorama image is generated from at least one camera to capture the wide-angle view over an activity area. Second, for each connected service user, a customer view frame is defined inside the panorama image frame. The customer view frame specifies the area inside the panorama image where the service user wants to have focused view presentation. The size and position of the customer view frame are determined according to user's view navigation inputs. The image data inside the customer view frame are extracted from the panorama view image and are processed into customer view image. The data transmission is minimized by sending individually specified customer view images to crowd users within communication throughput limit.

### TECHNICAL FIELD

This invention relates to an imaging system for providing crowd viewing service over large activity area like performance stages. A panorama view over an activity area is created and shared among all the connected service users, where each connected service user is provided with focused viewing over a subarea that is specified individually inside the panorama view.

### BACKGROUND

In stage performances, audience may not have clear and direct view over the performance when sitting too far away from the stage or when being blocked by other front audience. It is highly desirable to have a way to help all the audience to have equally nice view over the performer they love wherever they sit, even though when they are outside the auditorium.

Camera systems and mobile displaying devices, like smartphones and tablet computers, are more and more intensively involved in performance presentation. The auditorium cameras capture view image over the performance stage and send video streams that can be displayed to the audience on their mobile displaying devices. However, in conventional auditorium camera system, each camera can only provide limited view over the performance stage. An audience who uses camera system has to switch among many views from multiple cameras to view fixed areas of the stage. Some other system combines all the camera images to generate one wide-angle view image. This enable the audience to watch the whole performance but it loss the ability to focus at single performer or a unique region of interest. Moreover, when the image data is transmitted to the displaying devices of crowd audience, either the number of audience has to be very limited or the image quality has to be sacrificed due to the data message throughput of the communication system.

In order to provide a high quality and flexible view presentation system over activities like stage performance, this invention discloses method and system that provide service of focused view navigation inside a panorama view to crowd service users, where each service user has individually specified view region of interest. First, a high resolution panorama image is generated from the cameras to capture the wide-angle view over an activity area. Second, for each connected service user, a customer view frame is defined inside the panorama image frame. The customer view frame specifies the area inside the panorama image where the service user wants to have focused view presentation. The size and position of the customer view frame are determined according to user's view navigation inputs. The image data inside the customer view frame are extracted from the panorama view image and are processed into customer view image. The data transmission is minimized when sending only the customer view image to crowd users within communication throughput limit.

The invented view presentation system provides services at public activity places and performance auditoriums. Users can access the service from their displaying devices and navigate inside the panorama stage view until focusing at individually interested performer or region inside the activity area. Users have the flexibility to determine the size and quality of their presented view, as well as to record videos. As a result, each audience can make his/her own movie out of the same performance show using the same view presentation system. All the movies are different and each of them has individually specified focuses and details over different aspects of the same performance.

The invented crowd service imaging system may also comprise central or distributed audio receiving devices in the activity area. By determining the position of interest for each of the connected users based on his/her customer view frame and view navigation inputs, audio recourses are selected from available audio receiving devices and they are associated to the customer view service for each user individually. The audio signal data are then transmitted together with the customer view image data to user's displaying device and are presented together with the customer view image in a synchronized manner.

With the service provided by the invented view presentation system, the audience will no longer worry about being late to a performance show, sitting too far wary from the stage, being blocked by other audience. The audience can always direct the presentation of a performance to their individually-specified interested section of the performance with sufficient displaying clearness and focuses.

### SUMMARY OF THE INVENTION

The following summary provides an overview of various aspects of exemplary implementations of the invention. This summary is not intended to provide an exhaustive description of all of the important aspects of the invention, or to define the scope of the inventions. Rather, this summary is intended to serve as an introduction to the following description of illustrative embodiments.

Illustrative embodiments of the present invention are directed to a method and a system with a computer readable medium encoded with instructions for providing focused view navigation inside a panorama view for crowd service applications.

In a preferred embodiment of this invention, at least one video stream is captured from at least one camera system. A high resolution panorama image is generated from the image frame received from the camera video stream. For each connected service user, a customer view frame is defined inside the panorama image frame. The customer view frame specifies the area inside the panorama image where the service user wants to have focused view presentation. The size and position of the customer view frame are determined according to user's view navigation inputs. The image data inside the customer view frame are extracted from the panorama view image and are processed into customer view image. The customer view image is transmitted to user's terminal displaying device for displaying presentation and video recording.

The invention disclosed and claimed herein comprises generating a high resolution panorama image to provide overview image over an activity area or a performance stage. The panorama image can be produced from a camera image frame from a camera video stream. The whole camera image frame or a sub-image from the camera image frame can be used as the source for panorama image production. Additional information or image can be added to the final generated panorama image. The invention disclosed and claimed may further comprise a method for generating the panorama image from a plural of camera image frames that are captured from at least one camera system. The production of the panorama image using multiple camera image frames involves either an online image stitching method or an online image combination method that uses predefined image stitching scheme. In some applications, methods of 3D reconstruction from multiple images are used to generate 3D panorama view image to provide 3D view navigation capability. The resulted high resolution panorama image provides sufficient image coverage over the interested performance areas inside an activity area or stage.

In some embodiments of the present invention, the customer view frame is defined as a geometric area inside the frame area of the panorama image. The customer view frame has its properties including shape, size, and position in the panorama image. It may further has rotation angle, perspective angles and view height with respect to the panorama image. For each connected service user, the values of the properties are determined from received image navigation data that are obtained from the service user's displaying devices. A default customer view frame is used before user's image navigation data is received. Exemplary image navigation data from user's inputs to the user's displaying device comprise image left and right pan motions, image up and down tilt motions, image zoom-in and zoom out motions, and image clockwise and counter-clockwise rotation motions with respect to a determined motion center.

In some embodiments of the present invention, the customer view image is produced using image data extracted from the panorama view image data and such extracted image data corresponds to the portion of panorama image that is inside the customer view frame. The invention disclosed and claimed may further comprise producing the customer view image by processing the extracted image data using method comprising at least one of resize, resolution conversion, rotation, perspective transformation and 3D transformation. For each connected service user, the individually specified and produced customer view image is next transmitted to the service user's displaying device through a communication network.

In some embodiments of the present invention, the received customer view image is displayed on user's displaying device for live stage view presentation. Alternatively, the received customer view image data are encoded and saved into video files.

In some embodiments of the present invention, the invented view presentation system comprises central or distributed audio receiving devices in the activity area. By determining the target position of interest for each of the connected users based on his/her customer view frame data and view navigation inputs, audio recourses are selected from available audio receiving devices and they are associated to the customer view service for individual users. The associated audio signal data are then transmitted together with the customer view image data to user's displaying device and are played or recorded together with the customer view image in a synchronized manner.

Illustrative embodiments of the present invention are directed to method, system and apparatus for providing focused view navigation inside a panorama view for crowd service that enabling customized and focused view for each connected service user. Exemplary embodiments of the invention comprise at least one camera system; at least one displaying device; at least one communication network; and a computer based view presentation control service center. Additional features and advantages of the invention will be made apparent from the following detailed description of illustrative embodiments.

### BRIEF DESCRIPTION OF THE DRAWINGS

FIG. 1 is a schematic diagram of a stage view presentation system that provides individually controlled view navigation inside a panorama view for crowd service according to one or more embodiments;

FIG. 2 is a flowchart illustrating an exemplary service method of the individually controlled view navigation system for crowd service according to one or more embodiments;

FIG. 3 is a schematic diagram illustrating a method of generating 2D panorama view image model from a plural of camera view images according to one or more embodiments;

FIG. 4 is a flowchart illustrating a method of generating panorama view image model according to one or more embodiments;

FIG. 5 is a flowchart illustrating a method for service control and communication with connected service users according to one or more embodiments;

FIG. 6 is a flowchart illustrating a method for updating customer view frame according to received user's view navigation data according to one or more embodiments;

FIG. 7 is a schematic diagram illustrating a method for updating customer view frame and obtaining customer view image according to one or more embodiments;

FIG. 8 is a schematic diagram illustrating a method for generating customer view navigation data from user's input to a displaying device according to one or more embodiments;

FIG. 9 is a schematic diagram illustrating a method for generating 3D panorama image model and obtaining customer view image from individually controlled customer view frame according to one or more embodiments;

FIG. 10 is a flowchart illustrating a method for generating customer view image according to one or more embodiments.

FIG. 11 is a flowchart illustrating a method for customer view image presentation on a user's displaying device according to one or more embodiments.

FIG. 12 is a schematic diagram illustrating a view presentation service system with distributed audio receiving devices in a local activity area;

FIG. 13 is a flowchart illustrating a method for customer view presentation together with associated audio data received from audio receiving devices.

### DETAILED DESCRIPTION OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present invention discloses method and system for providing view navigation inside a panorama view for crowd service such that each connected service user can have individually controlled viewing area inside a commonly shared panorama view and can display the focused viewing area on their displaying devices. For each connected service user, the invented system controls a customer view frame inside the image frame of the panorama view image. The shape, size and position of the customer view frame are determined based on service user's selection and view navigation inputs. The customer view frame determines a sub-region inside the panorama image where the user wants the view presentation to focus on. The image data inside the customer view frame are extracted from the data structure of the panorama image and they are used to produce the customer view image that will be transmitted to the user's displaying device for displaying and video recording.

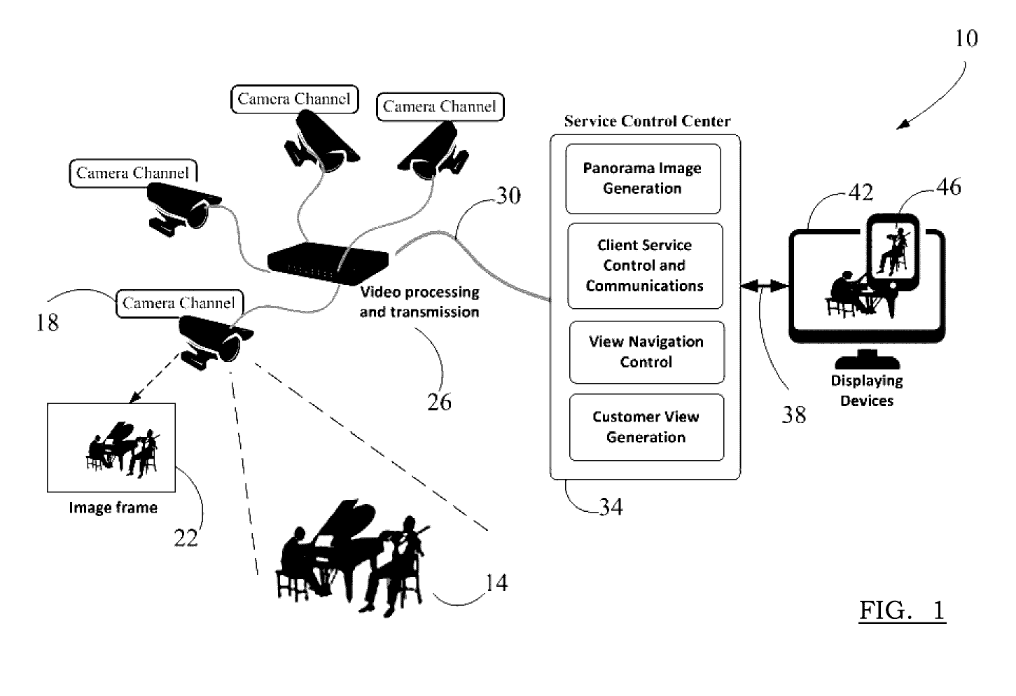

With reference to FIG. 1, a service system that provides individually control view navigation into a panorama view for crowd service is illustrated in accordance with one or more embodiments and is generally referenced by numeral 10. The service system 10 comprises at least one camera system that has at least one camera channel 18 for capturing view streams, a video processing and transmission unit 26, a computer based service control center 34, at least one user's displaying device 42 that connects to the service control center 34 through a communication network 38. The communication network 38 connects all the devices in the service system for data and instruction communications. Primary embodiments of the communication network are realized by the WiFi network and Ethernet cable connections. Alternative embodiments comprise wired communication networks (Internet, Intranet, telephone network, controller area network, Local Interconnect Network, etc.) and wireless networks (mobile network, cellular network, Bluetooth, etc.). Extensions of the service system also comprise other intern& based devices and services for storing and sharing recorded customer view videos as well as the service center recorded panorama view videos.

In the illustration, an activity area is represented by a performance stage 14 that is captured in the view image of at least one camera system 18. A camera system 18 comprises a camera device for capturing view image stream and for transforming the camera view into digital or analog signals. The camera device is either a static camera device or a Pan-Tilt (PT) camera device. A static camera device has fixed orientation. At a certain zooming ratio, the camera view frame has a fixed Field of Coverage (FoC) over the stage 14. When the performance stage 14 is quite large, the FoC of one camera system 18 is not sufficient and multiple cameras systems 18 are usually installed to achieve full stage coverage in camera view by coordination among all the camera view frames.

Other types of static camera devices, like pinhole cameras, can have full FoC over a performance stage 14. Since their view frames have strong distortion, their view frames have to be de-wrapped using 3D transformation to generate a final panorama view image. A PT camera device can adjust its orientation and zoom-in ratio to capture image over different areas of performance stage 14. At a single moment, the FoC of a PT camera system 18 may still be limited and multiple camera systems 18 are still needed to capture image over full performance stage 14 when it is large.

The camera system 18 may comprise a camera zoom controller that can change the camera zoom to adjust the FoC the camera view with respect to the performance stage 34. Changing the camera zoom also changes the relative image size of a performance stage 14 in the camera view. In some embodiments, the zoom controller is a mechanical device that adjusts the optical zoom of the camera device. In some other embodiments, the zoom controller is software based digital zoom device that crop the original camera view down to a centered area with the same aspect ratio as the original camera view. The camera system 18 connects to a video processing and networking unit 26. The video processing and networking unit 26 is a computerized device for networking camera system 18 and transferring camera view stream to the service control center 34. It also takes inputs from the service control center 34 to change the states of the camera system 18 and to report the camera system parameters.

The invented system comprises at least one camera system that captures at least one view stream. Camera view images from the camera view streams are used to generate the panorama image model. When a plural of camera view images are used to achieve sufficient view coverage and unobstructed view presentation, image combination method is used to produce the panorama image model. Exemplary image combination methods include but not limited to stitching method, 3D reconstruction method, image combination method with predefined image stitching scheme or 3D reconstruction scheme. By integrating the panorama image model generation and the view navigation method together, this invention achieves the application of crowd sharing based and individually controlled view presentation service uniquely and successfully.

A displaying device 42 is a computerized device that comprises memory, screen and at least one processor. It is connected to the service control center 34 through the communication network 38. Exemplary embodiments of displaying devices are smartphone, tablet computer, laptop computer, TV set, stadium large screen, etc. After receiving the customer view image data, the displaying device 42 displays the generated view image on its screen. Some exemplary embodiments of the displaying device have input interface, touch screen or mouse, to take user's view navigation commands and to communicate customer view navigation data with the service control center 34. Some embodiments of the displaying device comprises a set of sub-devices and the functionalities of displaying, vide-recording, customer view navigating, system configurations, video and sound control, etc. are distributed among the set of sub-devices.

The service control center 34 is a computer device that comprises memory and at least one processor. It is connected to the communication network through channels 30 and 38. The service control center 34 is designed to provide a bunch of system operation functions comprising panorama image generation, client service control and communication, view navigation control and customer view generation, etc. By allowing each connected customer displaying device 42 to navigate inside the panorama view and to obtain customer view image, each of the customer displaying device can display and record individually specified view 46 over interested section of the performance stage 14.

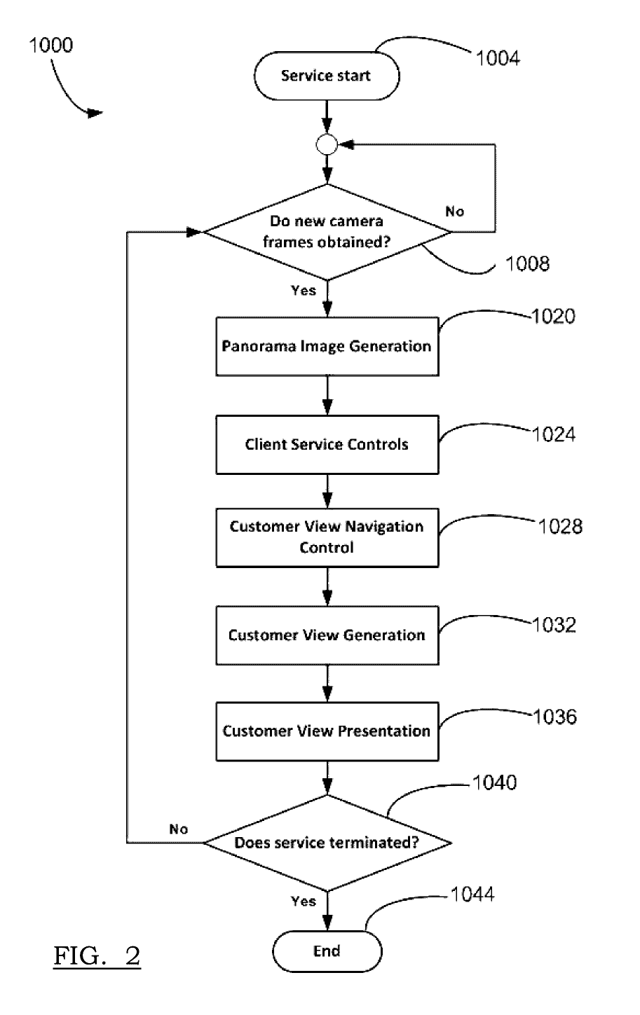

With reference to FIG. 2, an exemplary service method of the individually controlled view navigation system for crowd service is illustrated according to one or more embodiments and is generally referenced by numeral 1000. After starting at step 1004, this method first checks on if there is one or more newly captured camera view image frames from available camera view streams at step 1008. Once a new updating camera view image is available, a high resolution panorama view image model is generated based on one or a plural of camera view images at step 1020. The panorama view image model can be an image or other types of data structures containing data that can be used to construct a viewable image. Next at step 1024, client service control is carried out. The client service control establishes service connection with new user once service request is received and it manage all connected service users on their account information, profile data, view navigation data, view presentation parameters and other service communications between the service center system and the users' displaying devices. For each connected service user, the associated customer view frame is managed at step 1028. A frame of an image here is defined as the closed boundaries of the image with frame coordinates defined for it and for any point inside the frame. An exemplary image frame is a rectangular shape where the frame coordinates are defined by the image's pixel coordinate system. A view navigation frame is a geometric area inside the image frame of the panorama image frame. The view navigation frame has its properties defined with respect to the panorama image frame and such property parameters include but not limited to shape, size, relative position, relative rotation, etc. The image data corresponding to the panorama image inside the customer view frame can be extracted from the data structure of the panorama view image to produce customer view image. A connected service user may build up multiple view navigation services within one application and thus the user can have more than one controlled view navigation frames plus the overview frame that corresponds to the panorama view image frame managed by the service center system 34.

For each customer view frame, after initialized with default property parameters, its property parameters are determined and updated based on received view navigation data if received from user's displaying device 42. In an exemplary embodiment, user's view navigation input on a touch screen may comprise move-up, move-down, move-left, move-right, and rotation to a certain angle and in a certain direction (clockwise or counter-clockwise) with respect to a rotation center. Such view navigation inputs from the displaying device 42 are communicated to the service control center 34 and they are translated to the motion of the customer view frame inside the panorama view frame comprising tilt-up, tilt-down, pan-left, pan-right, and certain patterns of rotation, respectively.

Based on each customer view frame, a corresponding customer view image can be generated from the data extracted from the panorama image model at step 1032. A raw customer view image is first produced. Based on user's displaying settings and system configurations, the raw customer image can be further processed to finalize the customer view image through resize, 2D or 3D transformation, image decoration, image processing, etc. After that, the finalized image data are transmitted to the user's displaying device through the communication network 38. Socket communication methods are typically used to send the image data to the user's displaying device. The received final customer view image is then displayed on the user's displaying device at step 1036. In addition, the received final customer view image can be saved into video files. In some embodiment of this invention where centralized or distributed audio receiving device is used in the activity area, audio signal data are obtained from associated audio source that is identified from available audio receiving devices at step 1032. The received audio signal data are packaged together with the finalized customer view image data into media data messages in a synchronized manner. After that, the media data are transmitted to the user's displaying device through the communication network 38 to play the video and audio presentation lively together to service users.

The service method 1000 continues from step 1040 to step 1008 if the connected view navigation service is not terminated. Otherwise, it stops at step 1044. The service method illustrated in FIG. 2 only serves to present a minimal level of processing steps that the invented stage view service system comprises. In applications, service functions inside a realization of the invented stage view service system may take different sequences and their executions can be separated and may not depend on the completion of the previous steps.

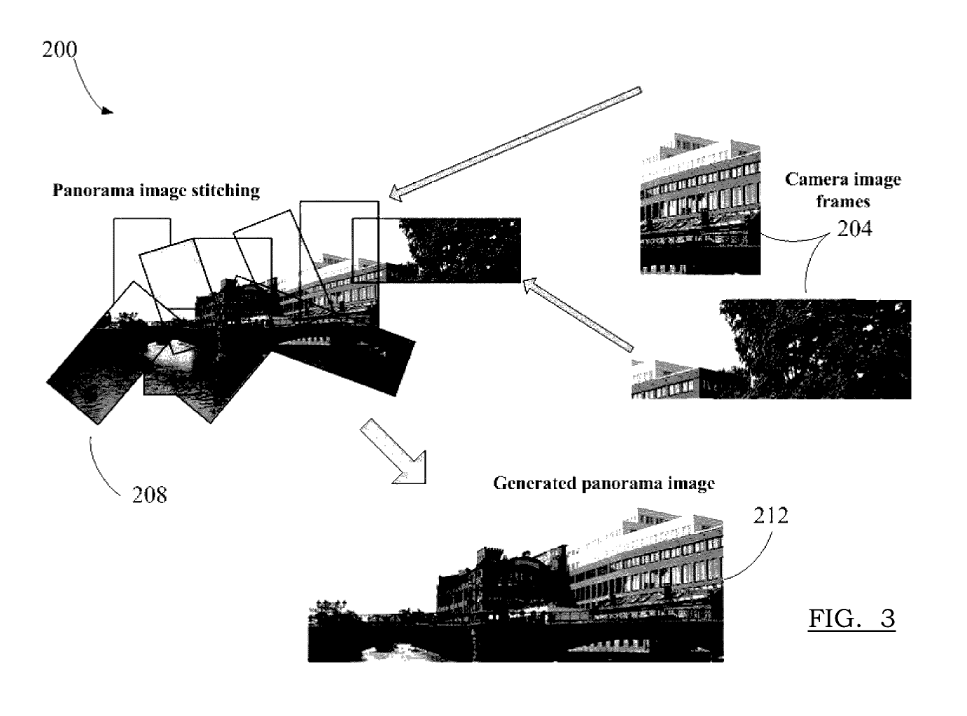

With reference to FIG. 3, a schematic diagram illustration for a method of generating 2D panorama view image model from a plural of camera view images is illustrated according to one or more embodiments and is generally referenced by numeral 200. This method starts with a plural of camera image frames 204 that are individually taken with overlaps in views over a scene or an activity area. Image stitching process 208 is used to combine the set of camera image frames to produce a high-resolution panorama image 212 through computer based image processing. The image stitching process can be divided into three main steps: image alignment, calibration, blending and composing.

For image alignment, a mathematical model is determined to relate pixel coordinates in one image to pixel coordinates in another. In some embodiments of the method, image registration that combines direct pixel-to-pixel comparisons are used to estimate parameters for the correct alignments relating various pairs of images. Image registration involves matching features in a set of images to search for image alignments that minimize the sum of absolute differences between overlapping pixels. Distinctive features can be found in each image and then efficiently matched to rapidly establish correspondences between pairs of images. For panoramic stitching the ideal set of images will have a reasonable amount of overlap (at least 15-30%) to overcome lens distortion and to have enough detectable features.

Image calibration aims to minimize differences of optical defects such as distortions, exposure differences between images, camera response and chromatic aberrations between an ideal lens models and the camera-lens combination that is used. Image blending involves executing the adjustments figured out in the calibration stage, combined with remapping of the images to an output projection. Colors are adjusted between images to compensate for exposure differences. After that, a final compositing surface 212 is prepared to warp or projectively transform and place all of the aligned images on it. In the composing phase, the types of transformations an image may go through are pure translation, pure rotation, similarity transform that includes translation, rotation and scaling of the image which needs to be transformed, Affine or projective transform. As a result, all the rectified images are aligned in such a way that they appear as a single shot of a scene. The composing steps can be automatically executed in online video stitching applications by applying a pre-defined or program controlled image alignment scheme with known blending parameters.

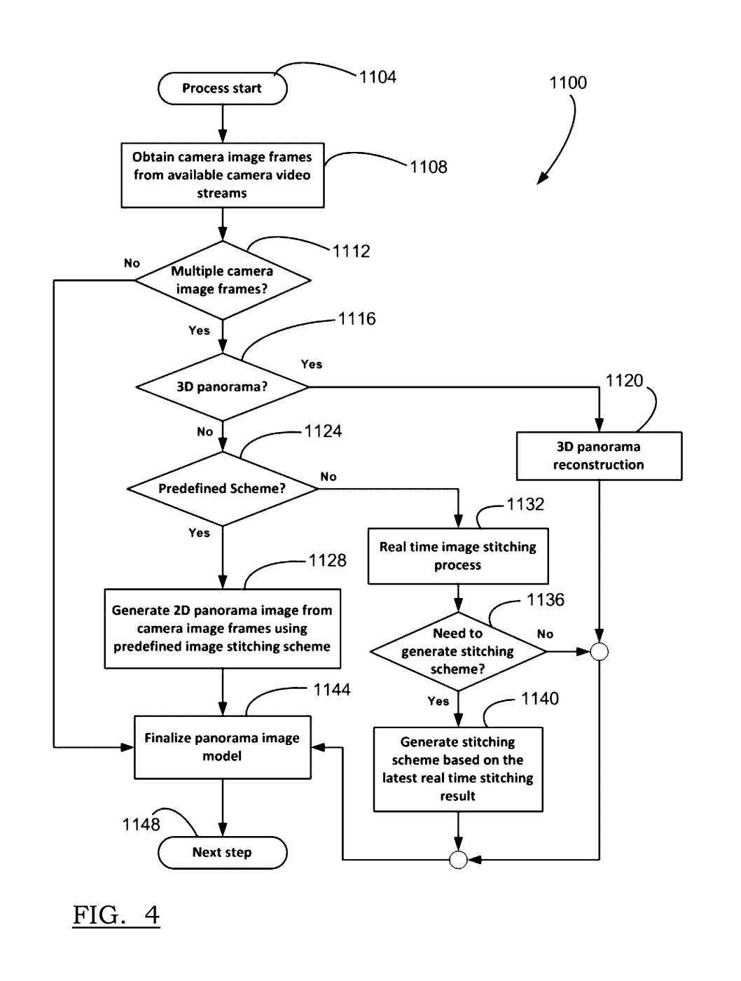

With reference to FIG. 4, a method of generating panorama view image model is illustrated according to one or more embodiments and is generally referenced by numeral 1100. After the process starts at step 1104, it first obtains camera image frames from available camera view streams at step 1108. If checked only one camera view frame is available at step 1112, the single camera view frame will be finalized to generate the data structure model for the panorama image at step 1144. Different types of image processing techniques may be used to produce the panorama image based on a portion or the full image data from the single available camera view frame. On the other hand, if multiple camera image frames are available, the method 1100 will start generating the final panorama image out of a subset or all of the available camera view frames. To this end, the method 1100 first checks if 3-dimension (3D) panorama model is to be produced at step 1116. 3D reconstruction methods are used to produce the 3D panorama view if needed. Then, additional image modification, decoration, description and overlapping images can be made to finalize the 3D panorama image data structure model at step 1144.

If only 2-dimension (2D) panorama model is required, the method 1100 next check on if a predefined image combination scheme shall be applied at step 1124. A predefined image combination scheme contains known image stitching alignment and composing parameters to simplify and facilitate the live panorama image producing process at step 1128, especially when the cameras used in the view navigation system are fixed with known orientation, zoom, illumination and optical lens parameters. In the circumstances where the available camera view frames are taken rather dynamically, real time image stitching process has to be applied in step 1132 to produce the panorama image through the alignment and composing steps with necessary calibration and blending. This will put a high requirement on the system computing and processing capabilities as well as the amount of memory needed to support the processing operations. GPU computing units are commonly used when such application is needed. After that, the live produced panorama image template will go through the same finalization process at step 1144 to generate the final panorama image date structure model.

In some embodiments of the view navigation system, the cameras used may only adjust its view capture parameters from time to time and all the parameter values stay fixed after the adjustments. In this case, the image stitching parameters after the adjustment is finished can be saved to generate image combination scheme, which can be used without change afterwards. If this is needed and validated at step 1136, a new image combination scheme is generated at step 1140 to support future panorama image production at step 1124 and step 11128. After finalizing the generated panorama image data structure model at step 1144, the method 1100 will continue to execute other service control processes at 1148 to complete the view navigation service function.

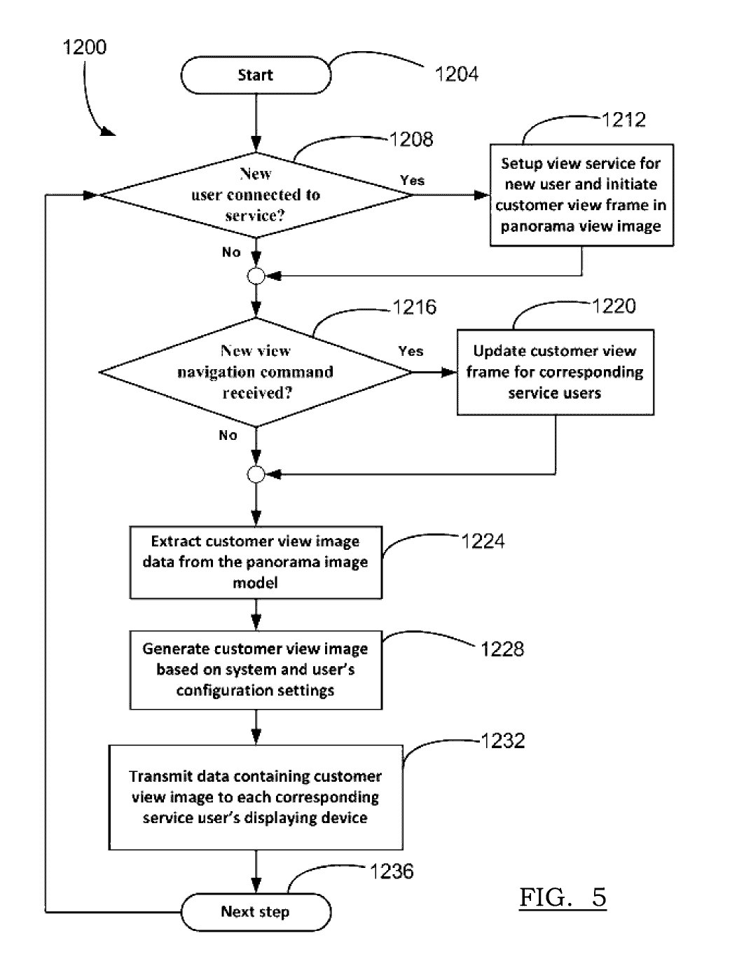

With reference to FIG. 5, a method for service control and communication with connected service users is illustrated according to one or more embodiments and is generally referenced by numeral 1200. After the process starts at step 1204, new user connection request is checked at step 1208. When new user connection request is received, the method 1200 will setup view service for the new user and initiate customer view frame in the panorama view image and other necessary system service parameters and configurations at step 1212. The method 1200 next checks for each connected service user if new view navigation command is received from connected user's displaying device. The view navigation command contains controls to adjust the relative position and size of the customer view frame to the panorama view frame. Once received, parameters associated to the customer view frame of corresponding service user will be adjusted accordingly. Based on the latest updated customer view frame data, customer view image data are extracted from the portion of panorama image model inside the customer view frame area at step 1224. The extracted image data are next processed at step 1228 to generate customer view image with additional image processing methods applied according to system and user's configuration setup parameters. Exemplary image processing methods include but not limited to image resize, similarity transform that includes translation, rotation and scaling of the image, format and data structure change of the image, as well as resolution conversion, perspective transformation and 3D transformation. Such image processing process can be finished at the service control center 34 or be extended fully or partially to the user's displaying device 42. After necessary process at the service control center 34, the customer view image data are transmitted together with other support service data to corresponding service user's displaying device 42 at step 1232. The method 1200 next continues at step 1236 back to check on new user connection request at step 1208.

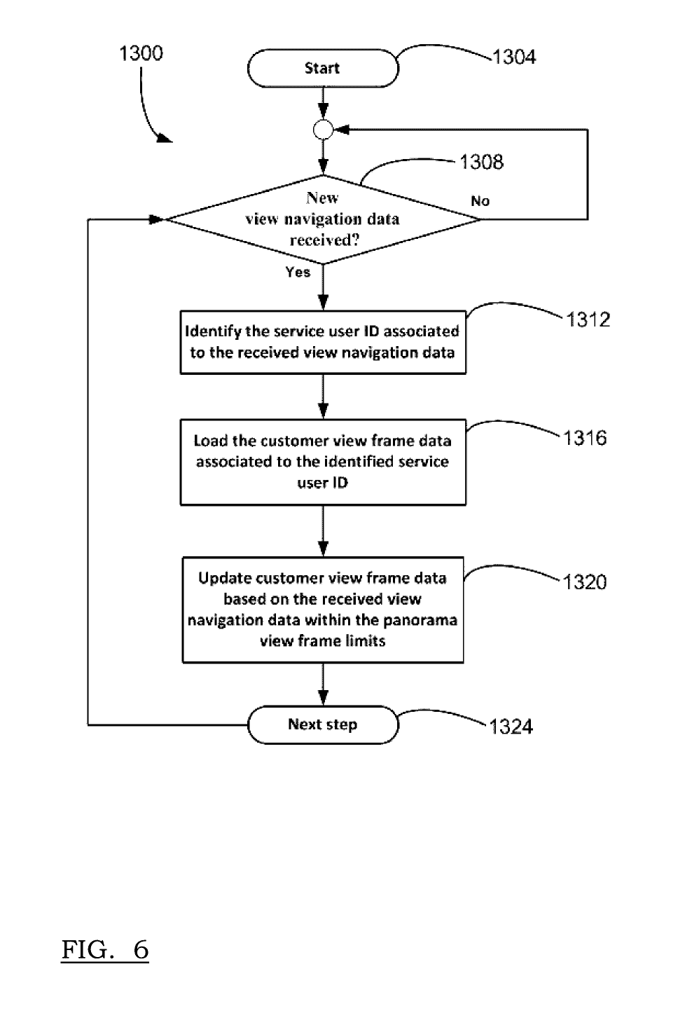

With reference to FIG. 6, a method for updating customer view frame according to received user's view navigation data is illustrated according to one or more embodiments and is generally referenced by numeral 1300. After starting at step 1304, the method waits till new view navigation date is received at step 1038. The service user ID embedded in the view navigation data is extracted next at step 1312. The data structure of the customer view frame data associated to the identified user ID is then loaded from system memory at step 1316. The service control center 34 next execute operation to update the values of the customer view frame parameters using the newly received vehicle navigation data while assuring that the newly updated parameter values are all satisfy system constraints and are within the panorama view frame limits at step 1320. Next at step 1324, the method 1300 continues to wait for receiving new view navigation data back to step 1308.

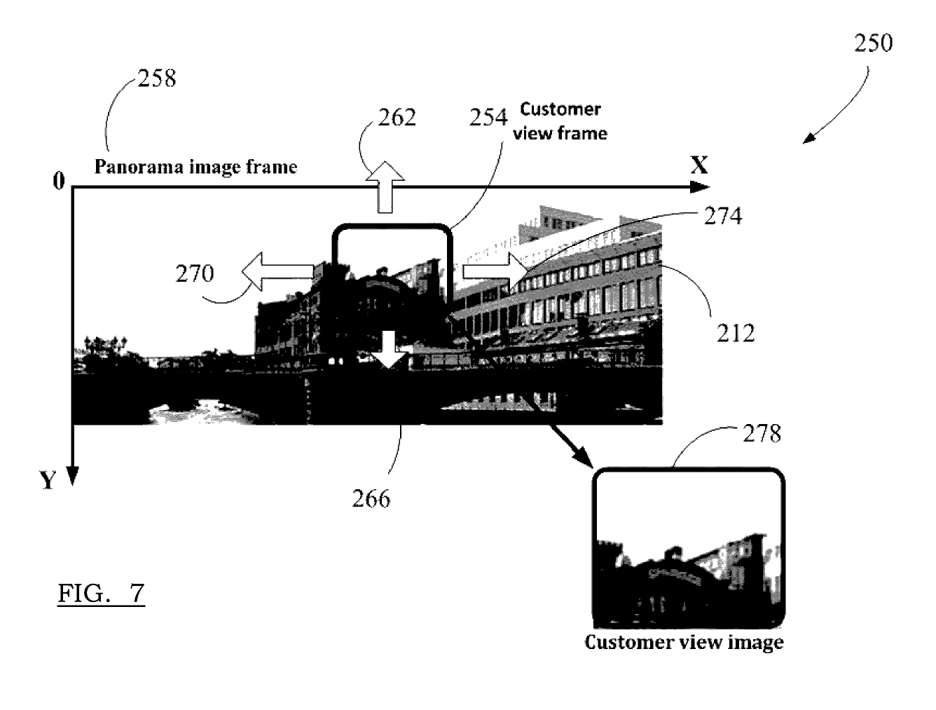

With reference to FIG. 7, a schematic diagram for a method of updating customer view frame and obtaining customer view image is illustrated according to one or more embodiments and is generally referenced by numeral 250. In this exemplary illustration, a rectangular shaped customer view frame 254 is used and only pan, tilt and zoom motions of the customer view frame are demonstrated for simplicity of presentation. Other shapes of customer view frame and more complex customer view frame motions involving similarity transform, affine and projective transforms can be applied to the navigation of the customer view frame in a similar manner.

First, a panorama image frame 258 is defined for the generated panorama image 212. The origin of the image pixel coordinate is defined at the left up corner of the panorama image. The horizontal axis defines the X-axis, which is also the axis for the pan motion of the customer view frame 254. The vertical axis downwards defines the Y-axis, which is also the axis for the tilt motion of the customer view frame 254. After being initialized at an initial position inside the panorama image frame 258, the position of the customer view frame 254 is determined based on the received relative motion commands from the customer view navigation data. Exemplary relative motions include the pan left motion 270, pan right motion 274, tilt up motion 262 and tilt down motion 266. The size of the customer view frame 254 can also be changed based on received zoom adjustment command from the customer view navigation data. The customer view frame 254 becomes relative large with respect to the panorama view frame when zoom-out command is received, and it becomes relative small when zoom-in command is received. The portion of the panorama image data inside the customer view frame is then extracted out of the data structure model of the panorama image to produce the customer view image 278. The customer view image 278 has its configuration properties including shape, size, resolution, color, image data format, etc. The generation of the customer view image 278 optionally includes steps of resize, resolution conversion, color format change, data format change, similarity transform, affine and projective transforms and 3D transformation.

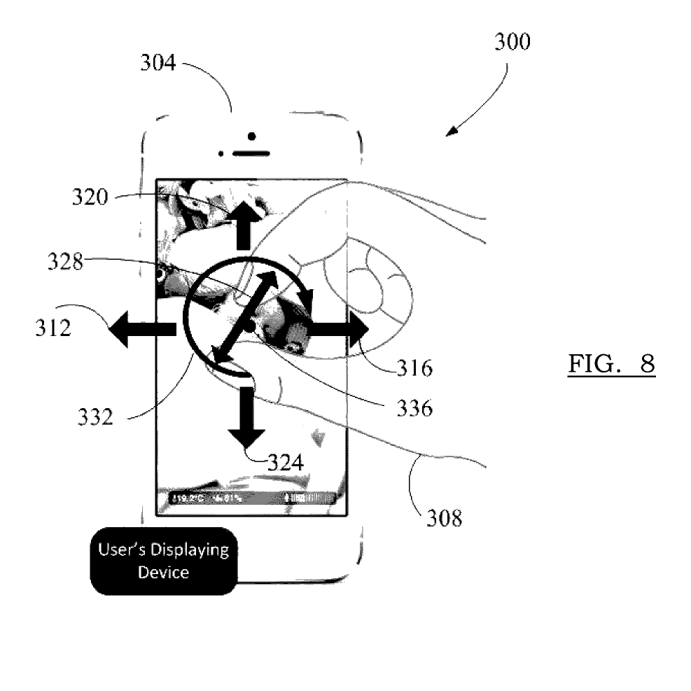

With reference to FIG. 8, a schematic diagram for a method of generating customer view navigation data from user's input to a displaying device is illustrated according to one or more embodiments and is generally referenced by numeral 300. In this exemplary illustration, the user's displaying device is represented by a cellphone 304 with an exemplary customer view image capturing a sleeping baby. And the user's input device is represented by hand fingers 308. In some other embodiments, the user's input device can be a computer mouse, a remote controller, a keyboard, and even a (vision, laser, radar, sonar, or infrared) sensor based gesture inputs.

On the touch screen of the cellphone, a figure slide left motion 312 is interpreted as pan left motion command to the customer view frame. Similarly, a figure slide right 316 commands pan right motion, a finger slide up 320 commands tilt up motion and a finger slide down 324 commands tilt down motion. A finger slide in an arbitrary angle can always be decomposed into the four basic finger slide motions described before. When detecting two finger touch on screen, the pixel point of the customer view image corresponds to the geometric center point between the touch point of the two finger on the screen is regarded as the motion center 336. The two finger stretch out motion 328 is then interpreted as zoom-in motion with respect to the motion center 336, while two finger close motion is interpreted as zoom-out motion of the customer view frame 254 inside the panorama image frame 258. The two figure touch rotation motion 332 is then directly interpreted as the customer view frame's rotation motion at a corresponding rotation angle in the same rotation direction with respect to the motion center 336. In such a similar manner, more complicated view navigation inputs can be generated to produce complex customer view motion relatively inside the panorama view frame 258 in order to view different areas inside the panorama view and in different view patterns.

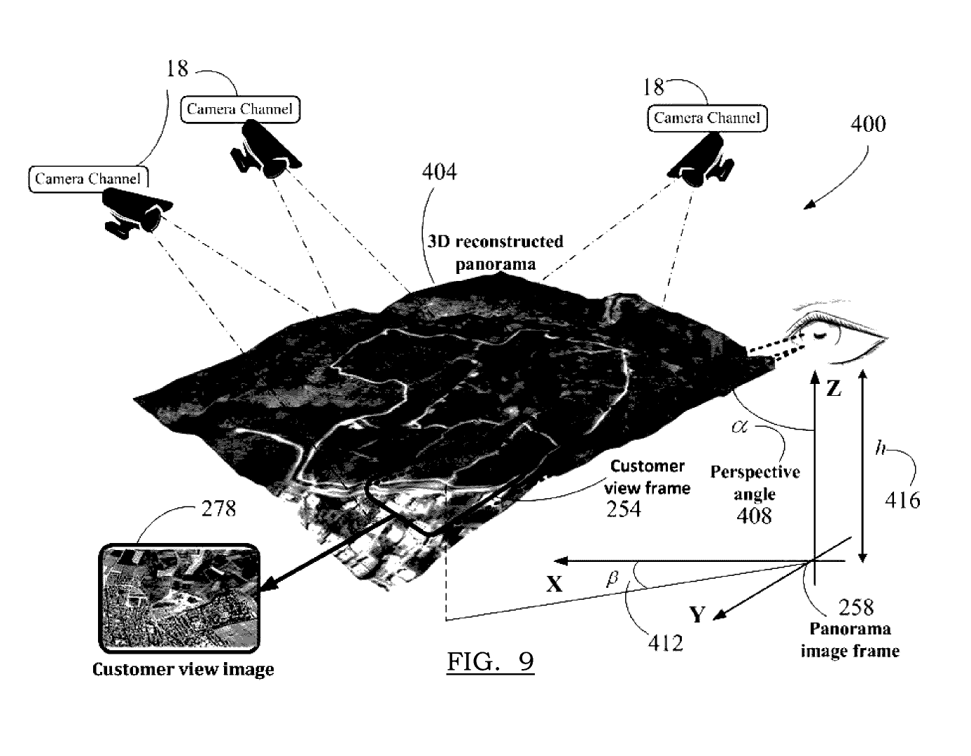

With reference to FIG. 9, a schematic diagram for a method of generating 3D panorama image model and obtaining customer view image from individually controlled customer view frame is illustrated according to one or more embodiments and is generally referenced by numeral 400. While image stitching method is used in 2D panorama image generation, the 3D panorama image mode construction takes advantage of the 3D reconstruction method. 3D reconstruction is the creation of three-dimensional models to capture the shape and appearance of real objects from a set of images. From two and more images that are taken from different perspective angles over an object by cameras 18, the position of 3D points on the object can be found as the intersection of the two projection rays. This process is referred to as triangulation. The key for this process is the relations between multiple views which convey the information that corresponding sets of points must contain some structure and that this structure is related to the poses and the calibration of the camera, which is important for determining depth. The correspondence problem, finding matches between two images so the position of the matched elements can then be triangulated in 3D space is similar to the matching point finding methods used in 2D image stitching method as described before. In FIG. 9, a 3D reconstructed terrain map 404 is used as an exemplary illustration of the 3D panorama model that contains object view from different perspective angles and relative depth with respect to a defined reference position.

For each connected service user, a customer view frame 254 is defined in the panorama image frame 258 of the panorama model 404. A rectangular shape is used again as an exemplary customer view frame for simplicity of expression. The customer view frame is a 2D shape over the 3D map and its position and shape determine where the data is to be extracted from the 3D panorama model for customer view image production. In the 3D panorama model, the panorama image frame 258 has one addition Z-axis. Besides the shape, position and size properties, the customer view frame in the 3D panorama model has its perspective angles α408 and β412 defined as well as view height h 416 defined to determine from where the customer is viewing the 3D map. When producing the customer view image 278, the raw image data are extracted from the 3D panorama model and then are processed through 3D projection transformations to finalize the output 2D customer view image.

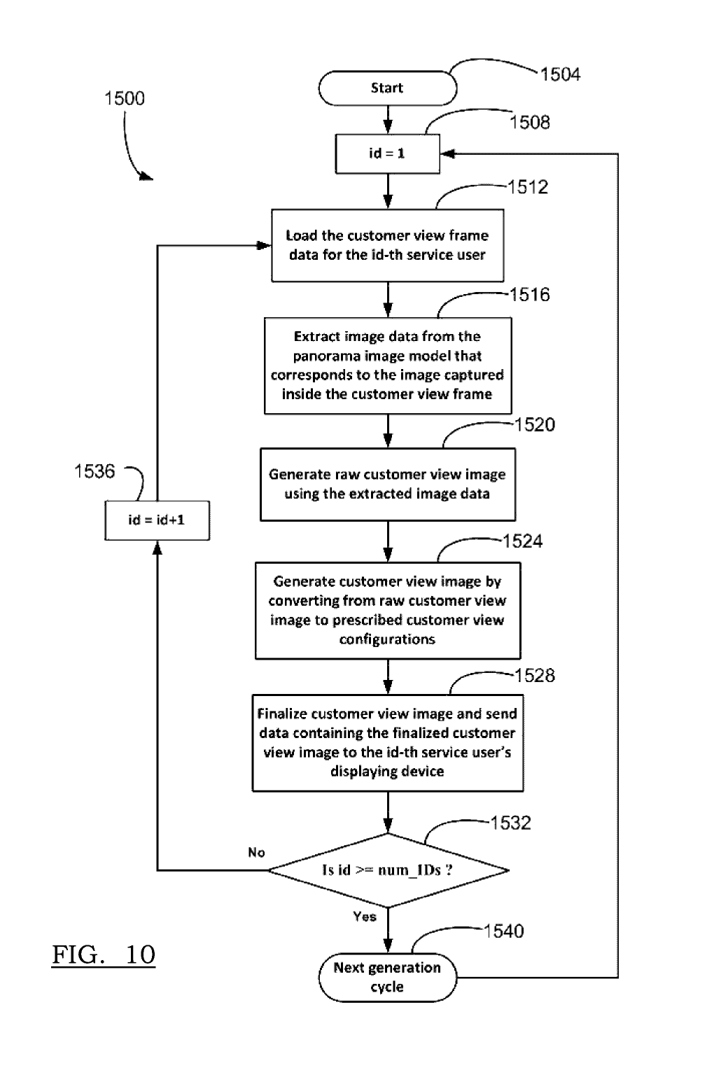

With reference to FIG. 10, a method for generating customer view image is illustrated according to one or more embodiments and is generally referenced by numeral 1500. After starting at step 1504, the method first work on customer view generation for the first connected user with id=1 at step 1508. The customer view frame data for the id-th connected user is loaded to the operator's memory from the system memory at step 1512. The shape, position and size of the customer view frame are used to identify the image data from the data structure of the panorama view image to be extracted. At step 1516, the image data associated to pixel position that is enclosed by the customer view frame are taken out and prepared for customer view generation in the next step 1520. In a simple exemplary case, for a rectangular customer view frame, the image area inside the rectangular area is directly copied to a customer view template and resized to make a raw version of the customer view image. The conversion on the raw customer view image may also apply image processing including resize, resolution conversion, color format change, data format change, similarity transform, affine and projective transforms and 3D transformation. At step 1528, the customer view image is finalized with optional add-on features including watermark, caption, highlight, decoration, overlapping image and even advertisement. The finalized customer view image is next send to the id-th service user's displaying device through the communication network 38. The method 1500 next checks on if the processing steps from 1512 to 1528 have been finished for all the connected users at step 1532. If not, the id will be added by one at step 1536 and the process goes back to step 1512 to start producing customer view image for the new id-th connected service user. When it is checked that all the customer view images have been successfully produced in this cycle at step 1532, the method 1500 next go to step 1540 to start a new cycle of generation process.

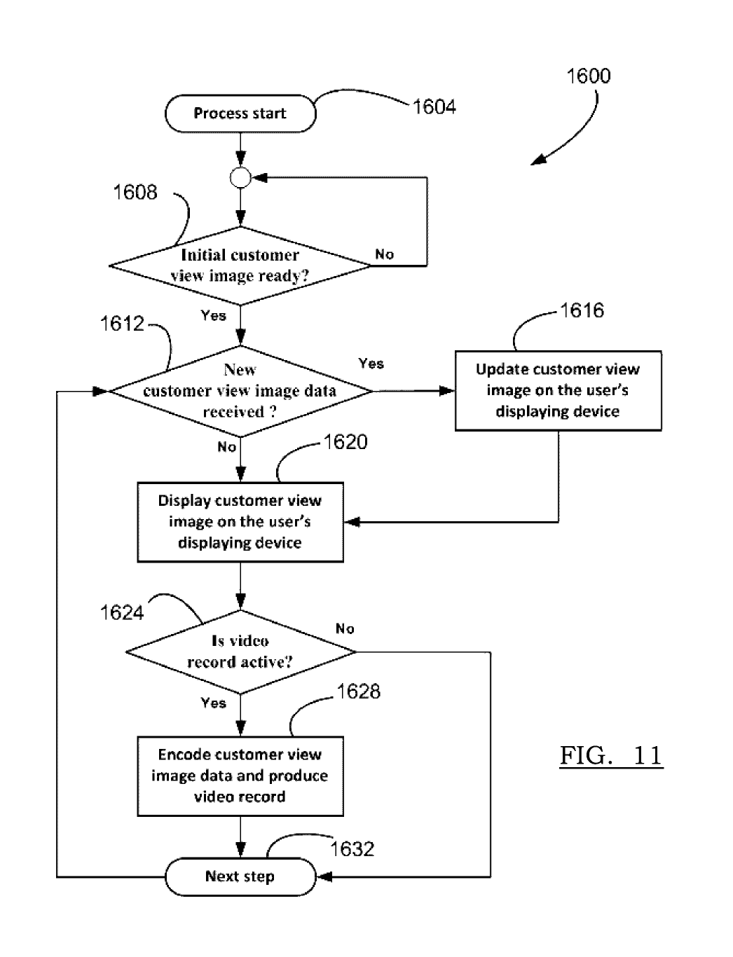

With reference to FIG. 11, a method for customer view image presentation on a user's displaying device is illustrated according to one or more embodiments and is generally referenced by numeral 1600. After starting at step 1604, the method first if an initial customer view image is ready at step 1608. The initial customer view image can either be a default service image loaded from user's displaying device or a customer view image that is produced by the service control center 34 based on a default or a latest updated customer view frame settings. Once the initial customer view image is ready, the view presentation service starts. At step 1612, the method 1600 checks on if new customer view image data is received from the service control center 34 based on the latest updated customer view frame data. When received, the customer view image data on the memory of the user's displaying device gets updated at step 1616. The most recently updated customer view image is then displayed on the user's displaying device at step 1620. The method 1600 next decides if video recording is requested based on user's input and settings at step 1624. If requested, the customer view image data are encoded and added to a target movie file at step 1628. Otherwise, after step 1632, the process switches back to step 1612 to check on new customer view image data reception. In this manner, customer view video stream is created and is continuously displayed and/or recorded on the user's displaying device.

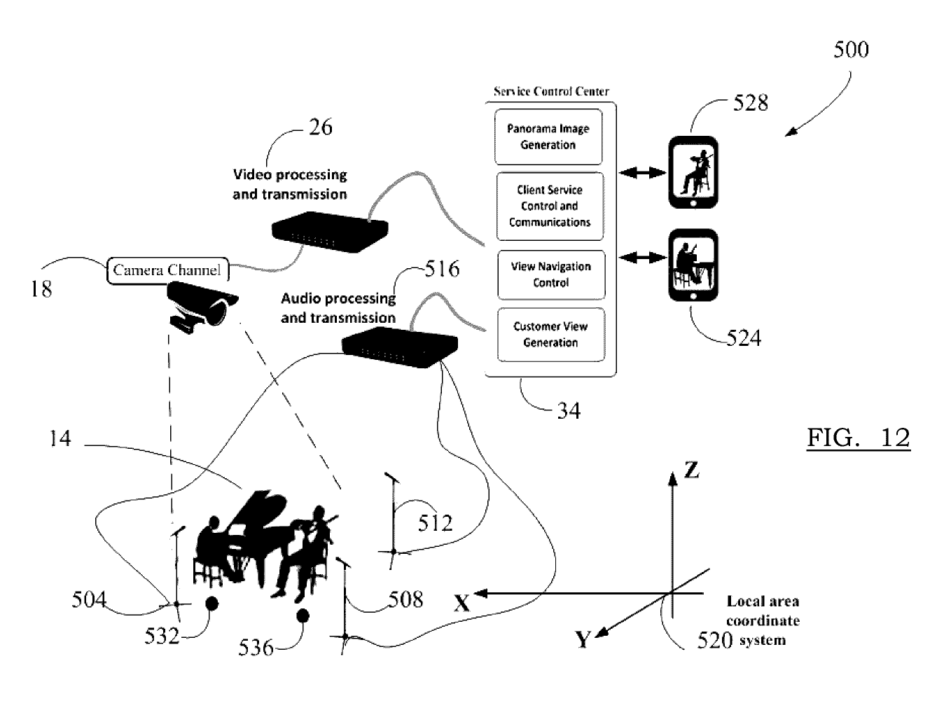

With reference to FIG. 12, a schematic diagram for a view presentation service system with distributed audio receiving devices in a local activity area is illustrated according to one or more embodiments and is generally referenced by numeral 500. The activity area is represented by a performance stage 14 where two musicians are playing. One is playing a plano and the other is playing a violin. Similarly as the illustration in FIG. 1, the view of the performance stage is covered by at least one camera system 18 that transfer camera view stream to the service control center 34 through a video processing and transmission unit 26 and the communication network. In addition to that, a local area coordinate system (LCS) 520 is defined for the activity area such that any position inside the activity area has unique coordinates to identify its location and to measure its distance to other objects inside the activity area. For example, the location of the left pianist is marked by position point 532 and the position of the right violinist is marked by position point 536.

Furthermore, a plural of audio receiving devices, represented by microphones 504, 508 and 512, are distributed around the performance stage. All the audio receiving devices have their known positions in LCS 520. Microphone 504 is the closest one to the pianist's position 532 and the microphone 508 is the nearest audio receiving device to the violinist's position 536. All the audio receiving devices are connected to an audio processing and transmission unit 516 to send received audio signals to the service control center 34. In this illustration, two service user's displaying devices 524 and 528 are connected to the service control center 34 through the communication network. For each connected service user, its target position of interest inside the activity area 14 is first determined based on service configuration, user's view navigation inputs. First, a reference point is specified inside the user's customer view image. This reference point can either be the center point of the customer view image, a user specified point or a program specified point on the customer view image. The pixel position of the reference point in the customer view image is then used to determine the geometric position of the reference point inside the customer view frame and subsequently to determine the pixel point of the reference point in the panorama image model. Furthermore, based on the pre-calibrated coordinate transformation formula from the panorama image' pixel coordinate system to the LCS 520, the target position of interest in LCS can be identified uniquely.

Next, the audio receiving device that is closest to the target position of interest in LCS is identified and it is associated to the service user. For example, the connected service 528 is focusing on the performance of the violinist and its associated audio receiving device is microphone 508. After that, audio signal data received from microphone 508 is packaged together with the customer view image data that are to be transmitted to the user's displaying device 528 and the combined media data are transmitted to user's displaying device 528 in a synchronized manner. As a result, the audio signal received from microphone 508 can be played lively with the focused customer view on user's displaying device 528. While the service user navigates his/her view inside the panorama view of the performance stage, associated audio resource are also being switches to the one that is closest to the instantaneously determined target position of interest inside LCS.

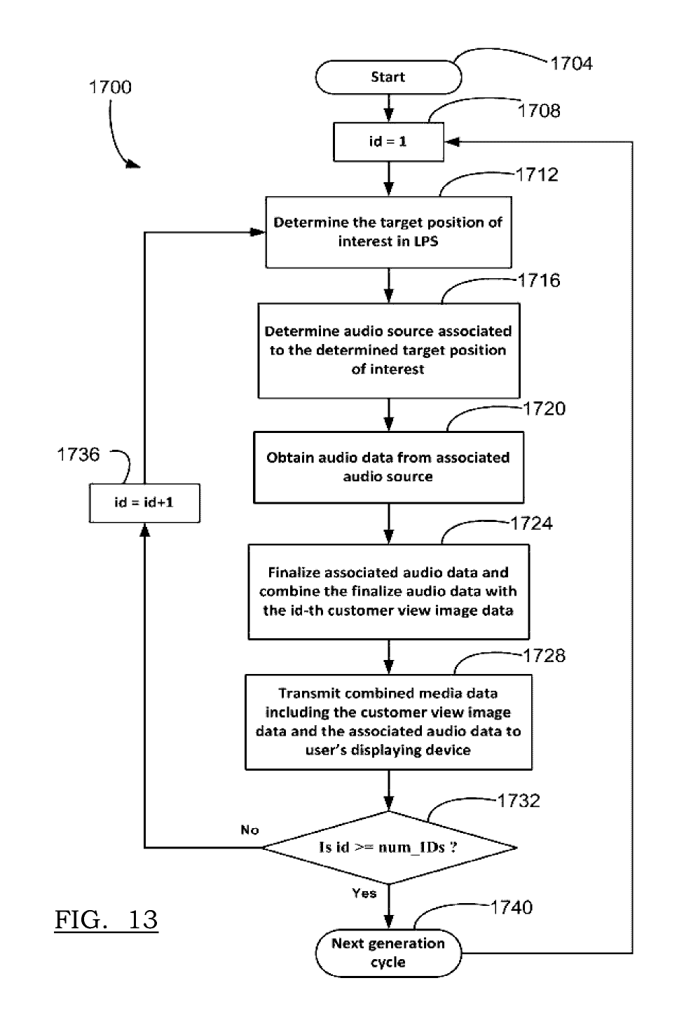

With reference to FIG. 13, a method for customer view presentation together with associated audio data received from audio receiving devices is illustrated according to one or more embodiments and is generally referenced by numeral 1700. After starting at step 1704, the method first work on media data generation for the first connected user with id=1 at step 1708. First at step 1712, the target position of interest for the id-th user is determined. In exemplary embodiments, the determination of the target position of interest inside the activity area can take any one of the following methods: 1). determining the target position of interest by the location inside the activity area that corresponds to a predefined image pixel position of the customer view image; 2). determining the position of interest by the local position inside the activity area that corresponds to a customer specified image pixel position in the customer view image; 3). determining the position of interest by the position of an object in the activity area. In the third method, the object is predefined and is recognized in the customer view image using image processing methods.

At step 1716, associated audio receiving device is determined for the id-th service user. Commonly used association methods include but not limited to: 1). Use the audio source that is closest to the determined target position of interest; 2). Use at least one selected audio source among audio sources that satisfy predefined condition of distance to the determined target position of interest. In this method, the selected audio source satisfies audio selection conditions comprising at least one of audio signal magnitude, sound quality, background noise level and sound frequency; 3). Use at least one selected audio source that is determined by a computer program that has selection conditions comprising at least one of distance to the target position of interest, audio signal magnitude, sound quality, background noise level and sound frequency.

At step 1528, the audio signal data is finalized with optional add-on features including background music, voice statement and comments, etc. The finalized audio signal data is next packaged together with the customer view image data that is prepared for the id-th service user to construct media data. The data package is done in a synchronized manner such that the media data, when used, playing the audio signal lively with the customer's individually specified view presentation. The combined media data is then transmitted to the id-th user's displaying device at step 1728 through the communication network 38. The method 1700 next checks on if the processing steps from 1712 to 1728 have been finished for all the connected users at step 1732. If not, the id will be added by one at step 1736 and the process goes back to step 1712 to start producing media data for the new id-th connected service user. When it is checked that all the media data have been successfully produced in this cycle at step 1732, the method 1700 next go to step 1740 to start a new cycle of generation process.

As demonstrated by the embodiments described above, the methods and systems of the present invention provide advantages over the prior art by integrating camera systems and displaying devices through view presentation control and communication methods and systems. The resulted service system is able to provide applications enabling flexible view navigation inside a commonly shared panorama view captured over activity area or performance stage. The data transmission is minimized when sending only the customer view image to crowd users within communication throughput limit.

While the best mode has been described in detail, those familiar with the art will recognize various alternative designs and embodiments within the scope of the following claims. Additionally, the features of various implementing embodiments may be combined to form further embodiments of the invention. While various embodiments may have been described as providing advantages or being preferred over other embodiments or prior art implementations with respect to one or more desired characteristics, those of ordinary skill in the art will recognize that one or more features or characteristics may be compromised to achieve desired system attributes, which depend on the specific application and implementation. These attributes may include, but are not limited to: cost, strength, durability, life cycle cost, marketability, appearance, packaging, size, serviceability, weight, manufacturability, ease of assembly, etc. The embodiments described herein that are described as less desirable than other embodiments or prior art implementations with respect to one or more characteristics are not outside the scope of the disclosure and may be desirable for particular applications. Additionally, the features of various implementing embodiments may be combined to form further embodiments of the invention.

1. A method for providing focused view that can be controlled by users to continuously navigate inside a panorama view for crowd service comprising:
obtaining at least one camera view image;
generating a panorama view image using said at least one camera view image;
for each connected user, determining a customer view frame inside the image frame of said panorama view image based on view navigation inputs received from said connected user via user's displaying device;
extracting image data inside said customer view frame from said panorama view image;
processing said extracted image data to generate customer view image;
transmitting image data of said customer view image to said user's displaying device;
playing said customer view image on said user's displaying device.

2. The method of claim 1, wherein said panorama view image is generated from a plurality of said camera view images using at least one of the following methods:
image stitching method;
3D reconstruction method;
image combination method that is based on a predefined image stitching scheme;
image combination method that is based on a predefined 3D reconstruction scheme.

3. The method of claim 1, wherein said customer view frame is a closed geometric region defined in the image frame of said panorama view image, and wherein said customer view frame has properties including size and position deter lined based on said view navigation inputs received from said connected user via user's displaying device.

4. The method of claim 1, wherein said view navigation inputs received from said user's displaying device can be decomposed into translational motions, zoom motions, rotation motions and perspective angular motions.

5. The method of claim 1, wherein said customer view image is generated by processing said extracted image data using method comprising at least one of resize, resolution conversion, format and color conversion, similarity transformation, perspective transformation and 3D transformation.

6. The method of claim 1, wherein said playing customer view image on said user's displaying device comprises at least one of:
displaying said customer view image;
recording video using said customer view image.

7. The method of claim 1 for providing focused view that can be controlled by users to continuously navigate inside a panorama view for crowd service further comprising:
determining a target position of interest inside an activity area;
obtaining audio data associated to said target position of interest;
transmitting said associated audio data together with said image data of said customer view image to said user's displaying device in a synchronized manner;
playing said associated audio data together with said customer view image on said user's displaying device in a synchronized manner

8. The method of claim 7, wherein said determination of said target position of interest inside said activity area comprises at least one of the following methods:
determining the position of interest by the local position inside said activity area that corresponds to a predefined image pixel position of said customer view image;
determining the position of interest by the local position inside said activity area that corresponds to a customer specified image pixel position in said customer view image;
determining the position of interest by the position of an object in said activity area, wherein said object is recognized in said customer view image.

9. The method of claim 7, wherein said associated audio data are obtained from at least one of:
the audio source that is closest to said target position of interest;
at least one selected audio source among audio sources that satisfy predefined condition of distance to said target position of interest, wherein said selected audio source satisfies audio selection conditions comprising at least one of audio signal magnitude, sound quality, background noise level and sound frequency;
at least one selected audio source that is determined by a computer program that has selection conditions comprising at least one of distance to said target position of interest, audio signal magnitude, sound quality, background noise level and sound frequency.

10. The method of claim 7, wherein said playing associated audio data together with said customer view image on said user's displaying device in a synchronized manner comprises at least one of:
playing said associated audio data together with said customer view image;
recording video using said customer view image and said associated audio data.

11. A system for providing focused view that can be controlled by users to continuously navigate inside a panorama view for crowd service comprising:
memory, configure to store a program of instructions and data;
a communication network;
at least one camera system to capture view image and to send image data;
at least one processor operably coupled to said memory, and said communication network, and said at least one camera to execute said program of instructions, wherein when said program of instruction is executed, carries out the steps of:
obtaining at least one camera view image from said least one camera system;
generating a panorama view image using said at least one camera view image;
for each connected user, determining a customer view frame inside the image frame of said panorama view image based on view navigation inputs received from said connected user via user's displaying device;
extracting image data inside said customer view frame from said panorama view image;
processing said extracted image data to generate customer view image;
transmitting image data of said customer view image to a user's displaying device.

12. The system of claim 11, wherein said panorama view image is generated by combining a plurality of camera view images using image combination methods and wherein said panorama view image is a data structure model stored on said memory.

13. The system of claim 11, wherein said customer view frame is a data structure stored on said memory that defines a closed geometric region in the image frame of said panorama view image, and wherein said data structure of said customer view frame comprises size and position parameters that take values determined based on said view navigation inputs received from said connected user via user's displaying device.

14. The system of claim 11, wherein said view navigation inputs are received from said user's displaying device via said communication network, and wherein said view navigation inputs comprises instructions that result in motions of said customer view frame including at least one of translational motion, zoom motion, rotation motion and perspective angular motion.

15. The system of claim 11, wherein said customer view image is generated by operations on said memory that result in changes on said extracted image data including at least one of resize, resolution change, format and color change, similarity transformation, perspective transformation and 3D transformation.

16. The system of claim 11 further comprises user's displaying device that when operated, results in action comprising:
taking user's input operations and translates said input operations into view navigation input parameters including at least one of view image resolution, size, perspective angels, rotation motion, translation motion, and zoom motion;
transmitting said user's navigation input parameters to said at least one processor via said communication network;
receiving image data from said at least one processor via said communication network;
displaying said received image data as customer view image;
recording video using received image data of customer view image.

17. The system of claim 11 further comprises at least one audio receiving device and wherein said at least one processor executes said program of instructions to further carry out steps of:
determining a target position of interest inside an activity area;
obtaining audio data associated to said target position of interest;
transmitting said associated audio data together with the image data of said customer view image to said user's displaying device in a synchronized manner.

18. The system of claim 17, wherein said step of determining said target position of interest inside said activity area comprises at least one of the following methods:
determining the position of interest by the local position inside said activity area that corresponds to a predefined image pixel position of said customer view image;
determining the position of interest by the local position inside said activity area that corresponds to a customer specified image pixel position in said customer view image;
determining the position of interest by the position of an object in said activity area, wherein said object is recognized in said customer view image.

19. The system of claim 17, wherein each of said at least one audio receiving device has its known local position in said activity area and wherein said step of obtaining associated audio data is carried out by receiving audio data from at least one of:
the audio receiving device that is closest to said target position of interest;
at least one selected audio receiving device among audio sources that satisfy predefined condition of distance to said target position of interest, wherein said selected audio receiving device satisfies audio selection conditions comprising at least one of audio signal magnitude, sound quality, background noise level and sound frequency;
at least one selected audio receiving device that is determined by a computer program that has selection conditions comprising at least one of distance to said target position of interest, audio signal magnitude, sound quality, background noise level and sound frequency.

20. The system of claim 16, wherein said user's displaying device is operated to further results in playing associated audio data together with said customer view image in a synchronized manner comprises at least one of:
playing said associated audio data together with said customer view image;
recording video using said customer view image and said associated audio data.
